(19) United States
(12) Patent Application Publication
(10) Pub. No.: US 2005/0252069 A1
(43) Pub. Date: Nov. 17, 2005

(54) Electronic flasher fishing lure

(75) Inventors: Richard B. Pool, Concord, CA (US); Cecil R. Spurgeon, Richmond, CA (US)

Correspondence Address: BRUCE & MCCOY, ONE KAISER PLAZA, STE. 750, OAKLAND, CA, 94612, US

(73) Assignee: PRO TROLL, Inc.

(21) Appl. No.: 10/844,687

(22) Filed: May 13, 2004

(51) Int. Cl. A01K 85/01; A01K 85/00; A01K 85/14

(52) U.S. Cl. 43/17.1; 43/43.13; 43/42.51

(57) ABSTRACT

An electronic flasher lure having a generally flat slightly trapezoidal panel with oppositely bent ends and a transversely projecting fin on the rear end thereof and a voltage emitter secured thereto which is actuated by the motion of the lure when it is trolled.

### BACKGROUND OF THE INVENTION

1. Field of the Invention

The present invention relates to artificial fishing lures and fish attractors. More particularly, it relates to flasher type trolling lure for use with a wide range of fish attractors and baits. Still more particularly, it relates to a combination flasher and voltage emitter trolling lure. Specifically, it is a uniquely variable speed trolling lure employing a combination of flasher and electronically generated voltage emitter to attract fish.

2. Description of the Prior Art

The use of lures in one form or another for the purpose of attracting fish has long been known in the prior art. However, despite the numerous designs, structures, and forms of artificial lures, baits, and fish attractors disclosed by and utilized in the prior art, which have been developed for the accomplishment of the specific objectives, purposes, and requirements of attracting different types of fish during different conditions and modes of fishing, the devices, machines, apparatus, and methods which have been heretofore devised and utilized to accomplish these goals consist basically of familiar, expected, and obvious configurations, combinations, and arrangements of well known apparatus. This will become apparent from the following consideration of the closest known and relevant prior art.

Fishing lures have been utilized as a means for catching fish long before the recordation and patenting of the prior art. Most lures, as the word “lure” indicates, are designed to lure a fish to attempt to eat the device and therefore they are designed to try to imitate or replicate the food of a fish. Fish attractors, in comparison and for definition, such as flashers, are designed to try to attract a fish's attention and draw it to a lure or a baited hook associated with the attractor. Artificial lures, as distinguished from organic bait (and which are commonly used in combination with organic material), have long been used for attracting both large and small fish in fresh and salt water. With the development of boat fishing and especially motorized boats, trolling has become a predominant way of sport fishing for salt and fresh water fish and requires different forms of artificial lures and fish attractors.

Fishing lures have been designed to replicate stimuli which cause fish to react to various forms of motion, sounds, odors, and the presence of electrical disturbances in the water in addition to the physical appearance of the lures. Fishing attractors and trolling flashers have long been used and accepted as a productive method of enhancing the action of trailing lures as well as a means of producing fish attracting vibrations and flashes of broken light in the water. Many lures try to combine two or more of the stimuli into a single lure with varying results. The artificial stimuli are not particularly complementary and are often self canceling or unintegratable as will be shown whereby the present invention solves at least one of these problems unlike any other known lure: it effects the integration of several types of stimuli.

The present invention is an electronic voltage emitter and flasher, salt and fresh water trolling lure, which utilizes several aspects of the various apparatus disclosed by some of the prior art, along with new and different features and specific apparatus configuration in a new and novel combination. It produces synergistic results not heretofore believed obtainable and which have been demonstrated in the practical applications and which are reflected in the marketplace by its proven acceptance.

With respect to the prior art, U.S. Pat. No. 3,056,228, issued Oct. 2, 1962, to Stackhouse for a Fish Lure discloses a flasher having a tapering body with rounded and bent ends. It is to be noted that the attachments for the fishing and bait lines are particularly located and considered important aspects of the invention. All of the features of the invention disclosure are considered by the inventor to be critical to the design, and it has a variable motion in the water depending upon the speed at which it is trolled: (col. 3, lines 65-70).

U.S. Pat. No. 3,656,253, issued Apr. 18, 1972, to Gaunt, for a Fishing Lure Flasher, is an improvement on Stackhouse in that it is covered with metallic reflector tape. While it is tapered and bent at the ends like Stackhouse, the end bends are irregular whereby at constant trolling speed it spins in large loops in first one direction and then the other to produce an irregular reflective pattern considered attractive to fish.

U.S. Pat. No. 4,122,624, issued Oct. 31, 1978, to Smith for a Fish Attractor discloses an improvement on both Stackhouse and Smith in that it is comprised of a transparent plastic sandwich to house a reflective material in the middle of the lure body to provide enhanced dimensional stability.

Other similar flashers are disclosed in U.S. Pat. No. 4,201,006, issued May 6, 1980, to Wetherald, for an Oscillating Flasher for Deepwater Fishing, and in U.S. Pat. No. 6,279,260 B1, issued Aug. 28, 2001, to Farr et al. for a Fishing Lure Flasher. These patents do not add further to the prior art with respect to the present invention, but they show that the motion of the lures in the water vary depending upon the speed with which they are trolled through the water by the fisherman.

A still more recent patent is related to the prior art by structure but it is claimed not by its fish catching function but by the motion it produces. U.S. Pat. No. 6,493,984 B1 issued Dec. 17, 2002, to Bechhold for Fishing Lure and Trolling Flasher discloses a tapered flat flasher lure distinguished by claiming a straight front stabilizing dorsal fin parallel to the longitudinal axis of the tapered body and an angulated perforated rear fin which, when trolled fast enough, induces infundibular rotational motion and whipping effect for supposedly producing sounds particularly attractive to fish.

With respect to the present invention, a further development in the art of fishing lures relates to a prior discovery by the inventor of the present invention and which has issued as U.S. Pat. No. 6,457,275 B1 issued Oct. 1, 2002, to Spurgeon for an Electronic Fishing Lure. That patent discloses an apparatus and method for attracting fish by means of an electronic voltage generator artificial fishing stimuli. The invention generates a small voltage discharge that emulates the electrical nerve discharges of small prey and bait fish thereby attracting predator fish. It has a steel ball enclosed in a metal tube with a piezoelectric crystal interconnected therewith, at one end thereof, which generates an electric voltage that is transmitted to the surrounding water when the ball strikes the end of the tube as a result of motion of the lure through the water oscillating the tube.

Anglers have determined that most fish prefer slow-moving baits traveling at speeds between one and four miles per hour. However, it has been determined that some flashers, as taught by the prior art, shake from side to side and rotate when pulled through the water. Others simply rotate with a uniform rotation. Both the shaking action and the rotation decay to a non-rotation, non-effective, random slow flutter when trolling speed drops below two miles per hour.

With respect to the use of particular species fishing lures, it is known that salmon congregate in schools and circulate just prior to running up river and spawning. They seem not willing to leave the fish school to chase fast bait but will take slow baits pulled through the school. The present invention is a successful attempt to combine the vibrations produced by prior art flashers with the visual tail kicking and oscillating motion of a flasher which activates an electronic field generator to emit a small voltage in the surrounding water and which can be towed at slow speed through a school fish, or at a wide range of higher speeds, to emulate the electrical nerve discharge of live bait fish for open water fishing.

The variable speed voltage emitter/flasher fishing lure contemplated according to the present invention departs substantially from the conventional concepts and designs taught and used by the prior art, and in doing so, provides an apparatus primarily developed for the purpose of overcoming the problems as described above, but it accomplishes the result in a different manner and with improved apparatus for attracting fish more assuredly, conveniently, repeatedly, faster, and successfully. The present invention has been designed to operate effectively at speeds as low as one mile per hour and in excess of three miles per hour while producing an irregular rotating motion which creates the necessary tail kicking action required to attract fish and excite a piezoelectric voltage generator into emitting a small voltage emulating the electric nerve discharge of a line bait fish.

### SUMMARY OF THE INVENTION

In view of the foregoing known, obvious, and described disadvantages inherent in the known types of flasher fishing attractors presently existing in the prior art, the present invention provides a new method, apparatus, and construction for a variable speed electronic flasher lure wherein the same can be utilized to catch fish by trolling the lure slowly through a school or congregation of fish or by trolling more rapidly in open water for foraging fish.

The general purpose and construction of the present invention, which will be described hereafter in greater detail, has been designed to provide a new and improved fishing lure which has many of the advantages of the prior art of flashers and fish attractors mentioned and described above. It is comprised of many novel features and advantages and performs the functions that result in a new and novel synergistic result which is not anticipated, rendered obvious, suggested, or even implied in total by any of the prior art of flasher lures and fish attractors heretofore known, either alone or in any combination thereof.

The present invention is an electronic flasher fish attractor lure comprised of an elongated generally rectangular central flat panel but having tapered side edges widening the panel slightly toward the rear end thereof. The panel has generally rounded end portions which are transversely bent across the panel and angulated relative to the longitudinal axis thereof. The end portions are bent in opposite direction parallel planes with equal degrees of angulation with respect to the plane of the panel and extend for approximately equal lengths at each end thereof. It has an angulated fin mounted on the rear end of the panel on the bent end portion thereof on the side of the panel which interposes the fin between the plane of the bent end and the plane of the panel. The fin extends substantially across the width of the panel end portion and has a height approximately equal to the height that the opposite bent end panel portion projects above the adjacent surface of the flat central portion of the panel. An electronic pulse generator is secured to the panel of the lure.

The more important features of the invention have been broadly outlined in the preceding summary of the invention in order that the detailed description thereof which follows may be better understood and in order that the present contribution to an improvement in the art of fishing lures may be better appreciated. There are additional features of the invention that will be described hereinafter and which will form the subject matter of the claims appended hereto.

With respect to the claims hereof, and before describing at least one preferred embodiment of the invention in detail, it is to be understood that the invention is not to be limited in its application to the details of construction and to the arrangements of the components which are set forth in the following description or illustrated in the accompanying drawings. The invention is capable of being created in other embodiments and of being practiced and carried out in various ways. Also, it is to be understood that the phraseology and terminology employed here are for the purpose of description and should not be regarded as limiting.

As such, those skilled in the art in which the invention is based will appreciate that the conception upon which this disclosure is predicated may readily be utilized as a basis for the designing of other forms, structures, apparatus, systems, and methods for carrying out the several purposes of the present invention. It is important, therefore, that the claims be regarded as including such equivalent constructions in so far as they do not depart from the spirit and scope of the present invention.

Further, the purpose of the appended abstract is to enable the United States Patent and Trademark Office, and the public generally, and especially scientists, engineers and practitioners of the art, who are not familiar with the patent and legal terms or phraseology, to determine quickly from cursory inspection the nature and essence of the technical disclosure of the application. The abstract is neither intended to define the invention of the specification, which is measured by the claims, nor is it intended to be limiting as to the scope of the invention in any way.

### OBJECTS OF THE INVENTION

It is therefore an important object of the present invention to provide a fishing lure or fish attractor which combines certain features of a flasher and an electronic voltage emitter trolling lure.

It is another object of the present invention to provide a trolling lure which can be trolled at slow speeds as well as variable higher speeds and in either event produce the attractive combined various fish stimuli of the lure.

It is a further object of the present invention to provide a salt and fresh water trolling lure which 1. Kicks spins and vibrates to appeal to the ability of fish to sense vibrations, 2. flashes for visual fish attraction and 3. creates an electric field around the lure which simulates the nerve discharges of a prey fish.

And it is still another object of the present invention to provide a salt and fresh water trolling lure fish attractor which can be utilized with organic or artificial bait.

Other objects and advantages of the present invention will become apparent when the method and apparatus of the present invention are considered in conjunction with the accompanying drawings.

### DESCRIPTION OF THE DRAWINGS

FIG. 1 is a top perspective view of the preferred embodiment of a fish attractor of the present invention;

FIG. 2 is a bottom perspective view thereof;

FIG. 3 is a top plan and view thereof;

FIG. 4 is a side elevation view thereof; and

FIG. 5 shows the asymmetrical motion of the present invention during trolling.

### DESCRIPTION OF THE PREFERRED EMBODIMENT

Reference is made to the drawings for a description of the preferred embodiment of the present invention wherein like reference numbers represent like elements on corresponding views.

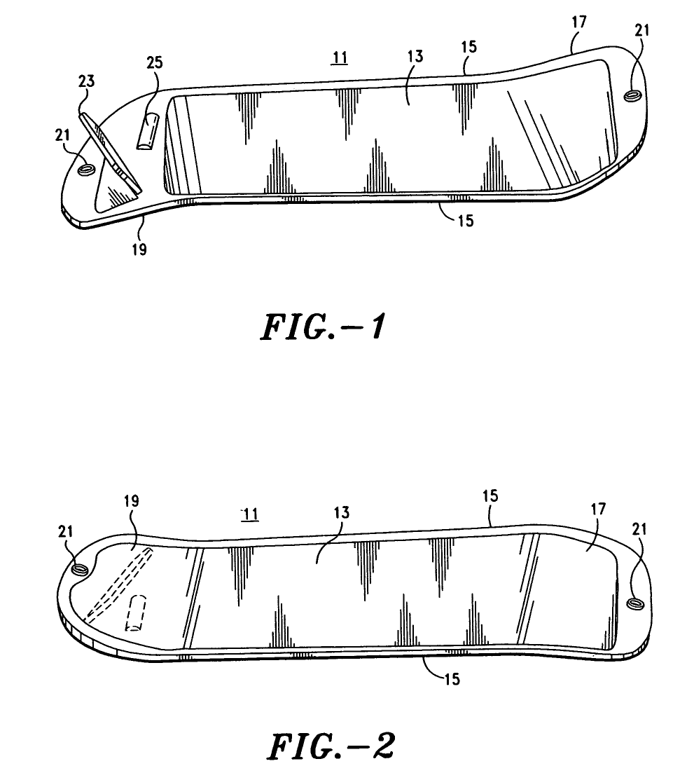

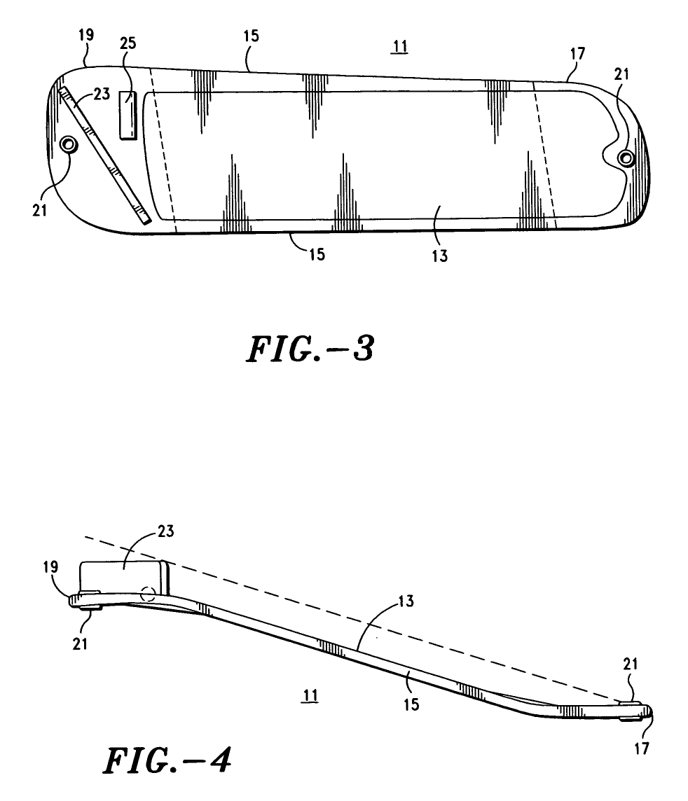

FIGS. 1-4 show the fish attractor apparatus as contemplated by the present invention. Thereshown is an electronic flasher lure 11 comprised of an elongated generally rectangular flat panel 13, but it has tapered side edges 15 widening the panel slightly toward the rear end 17 thereof. The panel is relatively thin and can be made of plastic, fiberglass, other compositions, or metal. The tapered shape of the flat panel forms non-parallel sides which make the rear end of the lure wider than the front end 19. Fishline or leader attachment holes 21 are provided on the centerline of the lure at both ends thereof. The rear hole can be utilized to trail a variety of one or more artificial lures or hooks which can further be imbedded in a bait fish.

The panel has generally rounded front and rear end portions 19, 17 which are transversely bent across the panel and angulated relative to the longitudinal axis thereof. The end portions are bent to lie in opposite direction parallel planes from the central panel portion 13. The transverse bends are angulated from an orientation of perpendicular to the longitudinal centerline of the lure 11. The bent ends 19, 17 have equal degrees of angulation of approximately 10 degrees with respect to the plane of the central panel, and they extend for equal lengths of approximately 20 percent of the length of the lure at each end thereof.

A diagonally angulated agitator fin 23 is mounted on the rear end 17 of the panel 13 on the bent end portion thereof on the side of the panel which interposes the position of the fin between the plane of the bent end portion and the plane of the panel. The fin extends substantially across the width of the panel end portion and has a height approximately equal to the height that the opposite bent end panel portion 19 projects above the adjacent surface of the flat central portion of the panel.

Reference is made to FIG. 4 for a visual representation of the height description of the agitator fin 23. A reference line is thereshown which runs from the front effective force line on the lure, which is the front fishing line attachment hole 21, parallel to the flat central panel of the lure, to the top of the closest or front end of the agitator fin. While slightly taller and slightly shorter fins will perform the agitator function almost just as well, the height of the fin described appears near optimum in performing its function in providing motion to the lure during trolling at a wide range of variable trolling speeds.

The combined configuration of the lure features causes the particular erratic tail kicking and spinning motion of the lure through the water during trolling which is required to attract fish with vibrations and to activate the electric voltage generation. It can be trolled between one and four miles per hour and have the same irregular rotary motion throughout those speeds which stimulates and actuates the voltage generator. A light-responsive surface is formed on a substantial portion of the surface area of the lure 11. Reflective, holographic, and luminescent materials in the form of adhesive tapes can be applied to both sides of the panel substantially covering the central flat panel 13 and both bent ends 19, 17 thereof. Adhesive mylar having a variety of surface textures and varied color and reflective appearances can be permanently pressed onto the panel surfaces. When the lure is pulled through the water, the irregular motion of the angulated reflective panels produces random omni-directional reflective patterns in the water.

An electronic voltage emitter or generator 25 is secured to the panel of the lure 11. In the preferred embodiment of the invention, the generator is secured to the panel near the rear end 17 thereof on the adjacent bent end portion. The generator is disclosed and described in the aforementioned U.S. Pat. No. 6,457,275 B1 (the '275 patent) which teaches that when the voltage generator or emitter is attached to a trolling lure which experiences jerky movement through the water, it is uniquely excited by the continuous repetitions kicking motion of the lure. The configuration of the lure apparatus is such that it produces a continuous tail kicking and spinning motion in the water during trolling irrespective of the speed so long as it is within normal trolling speeds.

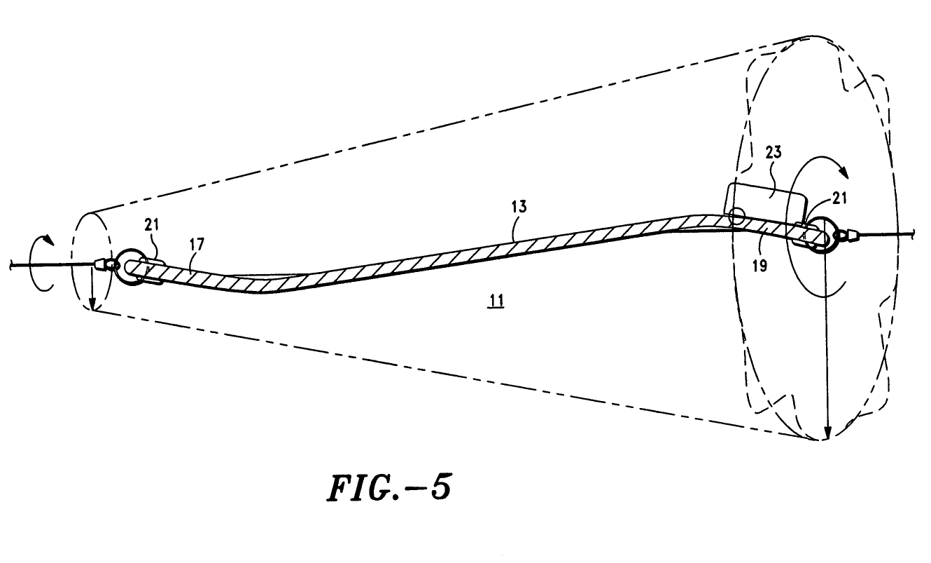

Reference is made to FIG. 5 which shows a diagram of the observed motion of the lure of the present invention which was intentionally predicted and designed for combined spinning, vibrating and tail kicking action and for the voltage emitter and improved through experimentation. The uneven whipping motion of the flasher caused by the design of the lure induces the piezoelectric voltage generator to emit small voltages radiating through the water emulating the electrical nerve discharges of bait fish thereby attracting predator fish and enhancing the possibility of a strike. The voltage pattern emitted seems to have a very attractive added inducement to many fish including salmon, trout, laketrout and many other species. This inducement is not present when the emitter is secured to other types of trolling lures which have a different motion in the water during trolling.

The present invention also teaches a method for effecting an electronic flasher variable speed trolling lure comprising the following steps. An elongated generally rectangular flat central panel is provided having tapered side edges widening the panel slightly toward the rear end thereof. The panel has generally rounded end portions which are transversely bent across the panel and angulated relative to the longitudinal axis thereof, and the end portions are bent in opposite direction parallel planes with equal degrees of angulation with respect to the plane of the panel and extend for approximately equal lengths at each end thereof. An angulated fin is mounted on the rear end of the panel on the bent end portion thereof on the side of the panel which interposes the fin between the plane of the bent end and the plane of the panel, the fin extending substantially across the width of the panel end portion and having a height approximately equal to the height that the opposite bent end panel portion projects above the adjacent surface of the flat central portion of the panel. An electronic voltage emitter or generator is secured to the panel of the lure near the rear end thereof on the bent end portion thereof. The lure is trolled between one and four miles per hour through the water to effect a jerking circular tail kicking and vibrating motion in the lure and to create a flashing light pattern in the water and to generate a varying voltage in the water surrounding the lure.

Thus, it will be apparent from the foregoing description of the invention in its preferred form that it will fulfill all the objects and advantages attributable thereto. While it is illustrated and described in considerable detail herein, the invention is not to be limited to such details as have been set forth except as may be necessitated by the appended claims.

1. An electronic flasher lure comprising
an elongated generally rectangular flat central panel having tapered side edges widening said panel slightly toward the rear end thereof, said panel having generally rounded end portions which are transversely bent across the panel and angulated relative to the longitudinal axis thereof, said end portions being bent in opposite direction parallel planes with equal degrees of angulation with respect to the plane of said panel and extend for approximately equal lengths at each end thereof,
an angulated fin mounted on the rear end of said panel on said bent end portion thereof on the side of said panel which interposes said fin between the plane of said bent end and the plane of said panel, said fin extending substantially across the width of said panel end portion and having a height approximately equal to the height that said opposite bent end panel portion projects above the adjacent surface of the flat central portion of said panel, and
an electronic voltage emitter or generator secured to said panel of said lure.

2. The electronic flasher lure of claim 1 wherein said generator is secured to said panel near the rear end thereof on said bent end thereof.

3. The electronic flasher lure of claim 1 wherein said end portions are angulated approximately 10 degrees with respect to the plane of said central panel.

4. The electronic flasher lure of claim 1 wherein said end portions extend for approximately 20 percent of the length of said lure.

5. The electronic flasher lure of claim 1 including a light responsive surface formed on a substantial portion of the surface area of said panel.

6. An electronic flasher lure comprising
an elongated generally rectangular flat central panel but having tapered side edges widening said panel slightly toward the rear end thereof, said panel having generally rounded end portions which are transversely bent across the panel and angulated relative to the longitudinal axis thereof, said end portions being bent in opposite direction parallel planes with approximately 10 degrees of angulation with respect to the plane of said panel and extend for approximately 20 percent of the length of said lure at each end thereof, said panel thereof including a light responsive surface formed on a substantial portion of the surface area of said panel,
an angulated fin mounted on the rear end of said panel on said bent end portion thereof on the side of said panel which interposes said fin between the plane of said bent end portion and the plane of said panel, said fin extending substantially across the width of said panel end portion and having a height approximately equal to the height that said opposite bent end panel portion projects above the adjacent surface of the flat central portion of said panel, and
an electronic voltage emitter or generator secured to said panel of said lure near the rear end thereof on said bent end portion thereof.

7. A method for effecting an electronic flasher variable speed trolling lure comprising the steps of:
providing an elongated generally rectangular flat reflective surface central panel having tapered side edges widening said panel slightly toward the rear end thereof, said panel having generally rounded end portions which are transversely bent across the panel and angulated relative to the longitudinal axis thereof, said end portions being bent in opposite direction parallel planes with equal degrees of angulation with respect to the plane of said panel and extend for approximately equal lengths at each end thereof, said panel having a reflective surface formed on a substantial portion of the surface thereof,
providing an angulated fin mounted on the rear end of said panel on said bent end portion thereof on the side of said panel which interposes said fin between the plane of said bent end and the plane of said panel, said fin extending substantially across the width of said panel end portion and having a height approximately equal to the height that said opposite bent end panel portion projects above the adjacent surface of the flat central portion of said panel,
securing an electronic voltage emitter or generator to said panel of said lure near the rear end thereof on said bent end portion thereof, and
trolling said lure between one and four miles per hour through the water to effect jerking circular tail kicking motion in said lure to create vibrations and a flashing light pattern in the water and to generate a varying voltage in the water surrounding said lure.
